(19) United States
(12) Patent Application Publication
(10) Pub. No.: US 2003/0079541 A1
(43) Pub. Date: May 1, 2003

(54) Optical sensors that resist delamination

(76) Inventors: Jeffrey B. Mecham, Blacksburg, VA (US); Kristie L. Cooper, Blacksburg, VA (US)

Correspondence Address: McGuire Woods LLP, Suite 1800, 1750 Tysons Boulevard, McLean, VA, 22102, US

(21) Appl. No.: 10/231,177

(22) Filed: Aug. 30, 2002

Related U.S. Application Data
(60) Provisional application No. 60/315,777, filed on Aug. 30, 2001.

(51) Int. Cl. G01N 19/00

(52) U.S. Cl. 73/335.01

(57) ABSTRACT

An optical sensor with alternating layers of high refractive indices and low refractive indices which resist delamination through the use of an interlayer bonding layer between the high refractive index layers and the low refractive index layers. Further the use of an overlay that covers substantially all of the alternating layers of high refractive indices may be used. The interlayer bonding layer and the overlay does not detract from the response time or accuracy of the sensor.

### RELATED APPLICATIONS

This application is based on U.S. Provisional Patent Application No. 60/315,777 filed on Aug. 30, 2001, herein incorporated by reference in its entirety.

### FIELD OF THE INVENTION

The present invention is directed to optical sensors, such as humidity sensors, fabricated using layer-by-layer electrostatic self-assembly processing which are resistant to delamination. More particularly, the present invention is directed to an interlayer bonding layer within the sensor or an overlayer over the top and the sides of the layers of the sensor to enhance the mechanical robustness of the sensor.

### BACKGROUND OF THE INVENTION

Optical sensors, such as humidity sensors, based on electrostatically self-assembled thin film materials on a substrate have been described by F. Arregui and coauthors. “Optical Fiber Humidity Sensor with Fast Response Time Using the ESA Process,” IEICE Transaction on Electronics, vol. E83-C, March 2000, p. 360-366, herein specifically incorporated by reference in its entirety. In such sensors, multilayer thin film materials are deposited layer-by-layer by electrostatic self-assembly processing methods. This method is based on the electrostatic attraction between oppositely charged molecular segments in each deposited layer. The electrostatic self-assembly method involves chemically treating the substrate to produce a charged surface on the substrate. As shown in FIG. 1, the charged substrate is alternately dipped into solutions of cationic and anionic polymers, or appropriately charged inorganic clusters to create a multilayer thin film. Reversing the surface charge for each successive monolayer allows for molecular adsorption and ionic binding. The individual layer thickness in the film can be controlled by adjusting the dipping parameters.

Using this method, films have been formed on the ends of optical fibers, where the fibers are used to guide input light from a light source to the films, and from the films to optical detectors. In these arrangements, by detecting the reflected light signal and also a reference portion of the light emitted by the light source, the two detected signals, signal and reference, may be used to effectively normalize and remove intensity variations due to the source or the transmission path from the measurement.

For a humidity sensor, the humidity can be determined by measuring the optical reflection of the films. The reflection coefficient of the thin films varies as a function of humidity. Two mechanisms result in a change in the reflection coefficient of the films due to humidity and allow for the measurement of humidity. One mechanism is an optical interference effect, in which the layer-by-layer process is used to create alternating blocks of layers that have, respectively, high and low refractive indices. The combination of these alternating blocks effectively forms a small multilayer filter, or reflector, or cavity. Humidity causes a change in the reflection coefficient of the outermost layer or layers of the cavity, and thus the reflection coefficient of the entire film. These types of humidity sensors may be instrumented using singlemode optical fiber, because singlemode fiber preserves optical coherence properties.

The second mechanism is a simple reflection change in one or several deposited layers, but is not associated with the multilayer interference effect indicated above. These intensity-based devices may be implemented using multimode fiber, since the maintenance of coherence properties is not important.

The materials that have been used to fabricate humidity sensor films have typically been polymers, such as poly(diallyldimethyl ammonium chloride) (PDDA+) and poly(sodium-4-styrenesulfonate) (PSS−), but may include oxide and metal nanoclusters and other materials, where there is an electrical charge reversal between each of the individual layers deposited. These films may be formed on the surfaces of integrated optical waveguides or bulk optical components, and optical arrangements other than optical fibers used to provide incident light and to measure reflected light. In all of these cases, the reflection coefficient of the thin films varies as a function of humidity.

One advantage of electrostatically self-assembled thin film optical humidity sensors based on water molecule transport through the film is that the films are so thin that the time required for humidity in the external atmosphere to enter and interact with the film and change its reflection coefficient is very low. Similarly, the time required for water molecules to be transported out and away from the films is also small. The time response of the sensors is very fast, and 10-90% amplitude rise-times and 90-10% recovery fall-times can be in the millisecond range.

Another advantage of the electrostatic self-assembly process for fabricating humidity or other chemical vapor sensors where the molecules are adsorbed onto the topmost layer of the thin film is that the chemistry of that layer may be varied by controlling the materials in the alternating layers or a top protective layer.

Another advantage of these sensors is that by using the ends of optical fiber waveguides as the location of the deposited thin films, the size of the sensors are physically small. This allows convenient packaging for applications in industry and biomedical sensing.

However, the layers in the films of the sensor tend to delaminate. Delamination of the layers in the film shortens the useful life of a sensor. Accordingly, there is a need to provide a sensor that resists delamination while still maintaining the useful advantages of the thin film optical-based humidity sensor devices.

### SUMMARY OF THE INVENTION

It is an object of the present invention to provide an optical sensor that resists delamination.

Accordingly, one embodiment of the present invention includes a sensor having alternating layers of high and low refractive indices on an end of a substrate. The layer having a high refractive index may include multiple oppositely charged layers of at least a first and second material layers. The layer having a low refractive index may include multiple oppositely charged layers of at least a third and forth material layers. In accordance with one embodiment an overlayer substantially surrounds the alternating layers.

The first material layer may be selected from the group consisting of poly S-119 and poly R-478. The second material layer may include PDDA. The third material layer may include PSS and the fourth material layer may include PDDA.

In accordance with one particular embodiment, the first material layer is poly S119, the second material layer is PDDA, the third material layer is PSS, and the fourth material layer is PDDA.

In another embodiment, one of the second material layer and the forth material layers may include an interlayer bonding layer between at least on of the first, second, third and forth material layers which includes a copolymer of PDDA and polyacrylamide.

The number of alternating layers of high and low refractive indices ranges from about 1 to about 50. In certain embodiments, the layer having a high refractive index preferably has a refractive index of at least about 1.55 and the layer having a low refractive index has a refractive index lower than about 1.52. Each oppositely charged layer may range from about 0.1 nm to about 100 nm thick.

The overlayer is preferably a resinous material selected from the group consisting of polymers with controlled thickness and molecular transport properties. The overlayer preferrably has a thickness ranging from about 1 nm to about 100 nm

The substrate is preferably selected from the group consisting of glass, an optical fiber, singlemode fiber, multimode fiber, an optical wave guide, and an optical substrate.

In accordance with yet another embodiment of the present invention also may include an optical sensor having at least two alternating layers having different refractive indices on an end of a substrate where one alternating layer includes multiple oppositely charged layers of at least a first and second material layer held together by electrostatic charges, and where the second alternating layer comprises multiple oppositely charged layers of at least a third and forth material layer held together by electrostatic charges, where an interlayer bonding layer separates at least one of the first, second, third and forth material layers.

Preferably, the at least two alternating layers have refractive indices differing by at least about 0.03. In preferred embodiments, the interlayer bonding layer is a copolymer of PDDA and polyacrylamide. The optical substrate may be selected from the group consisting of glass, an optical fiber, singlemode fiber, multimode fiber, an optical wave guide, and an optical substrate. The interlayer bonding layer is preferrably a material selected from the group consisting of polymers with controlled thickness and molecular transport properties. In certain embodiments, the first material layer may be selected from the group consisting of poly S-119 and poly R-478, and said second material layer may be PDDA.

### BRIEF DESCRIPTION OF THE DRAWINGS

FIG. 1 illustrates the electrostatic self-assembly process schematic for buildup of multilayer assemblies by consecutive adsorption of anionic and cationic molecule-based polyelectrolytes.

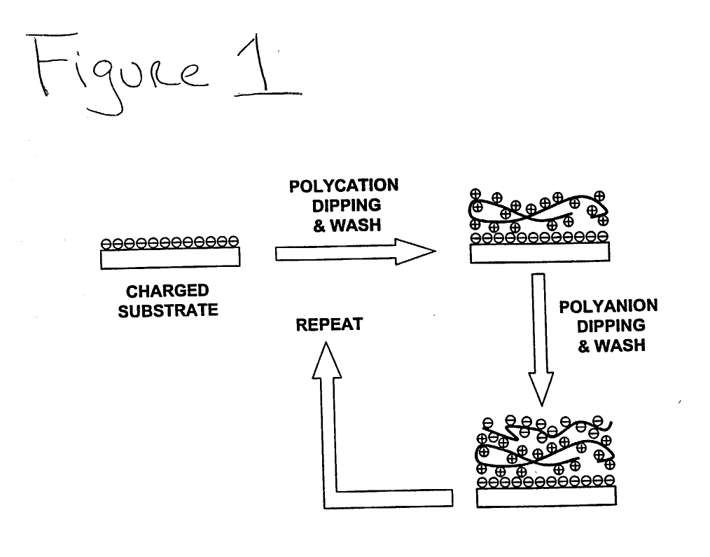

FIG. 2 illustrates an optical sensor in accordance with one embodiment of the present invention.

FIG. 3 is a cross-sectional view of a sensor in accordance with another embodiment of the present invention where an overlayer on the top and sides of the layers is shown.

FIG. 4 is a plot of ammonia absorption as a function of time for a sensor of the present invention.

### DESCRIPTION OF THE INVENTION

A sensor for a variety of conditions or chemical moieties may be made by constructing alternating layers of high and low refractive indices on an end of a substrate. The alternating layers may be constructed using the previously described electrostatically self-assembly method. The present invention is directed to providing an optical sensor that resists delamination of high refractive index layers and the low refractive index layers. As will be discussed in detail below, delamination of layers in the film may be reduced by the inclusion of an interlayer bonding layer in one or more of the layers. Delamination is also reduced by the inclusion of a overlayer on the top and sides of the layers. In accordance with one embodiment, an overlayer may be used in conjunction with the interlayer bonding layer to further improve the robustness of the sensor.

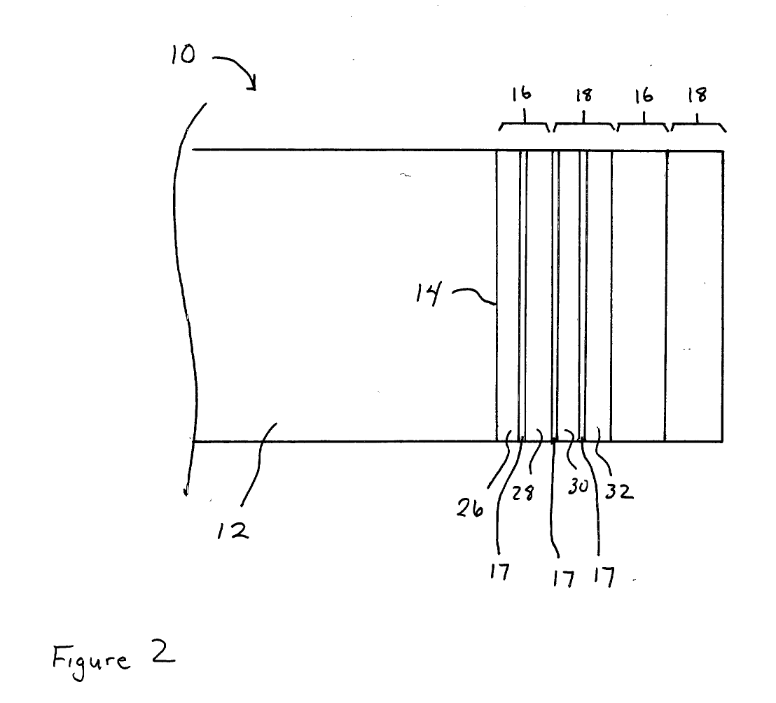

Turning now to FIG. 2, there is shown a sensor in accordance with one embodiment of the present invention. The sensor 10 includes a substrate 12. For an optical sensor, it is preferred that the substrate be made of a material that does not interfere with light. The substrate 12 may include, but is not limited to, glass, an optical fiber, singlemode fiber, multimode fiber, an optical wave guide, an optical substrate, or the like. The end 14 of the substrate 12 may be cleaved to form a smooth surface or it may be polished.

Extending from the end 14 of the substrate 12 is alternating layers of a high refractive index layer 16 and a low refractive index layer 18. While FIG. 2 illustrates the high refractive index layer 16 as the first layer extending from the end of the substrate, the order of the layers extending from the end of the substrate may be reversed so that the low refractive index layer 18 may be the first layer extending from the end of the substrate. For illustration purposes, the high refractive index layer 16 will be the first layer extending from the end of the substrate 12. The high refractive index layers and the low refractive index layer continue alternating until the desired number of layers are achieved. The number of alternating layers may vary depending upon the application of the sensor. In preferred embodiments, the number of alternating layers ranges from about 1 to about 50. In preferred embodiments, the difference in the refractive index between the high refractive index layers and the low refractive index layers is at least about 0.03. In certain embodiments the high refractive index layer is at least about 1.55 and the low refractive index layer is lower than about 1.53.

Each high refractive index layer 16 is made up of at least one pair of alternating oppositely charged first and second material layers 26 and 28 and are constructed in accordance with the general principles of the electrostatic self assembly method described previously. Examples of alternating oppositely charged first and second material layers for a high refractive index layer combinations include, but are not limited to, the combination of PDDA+ and poly S-119− or the combination of PDDA+ and poly R-478−. Further, combination of metal oxides with PDDA+, such as ZnO₂ or SnO₂ may be used as well. Depending on the charge the surface of the substrate 12, the first material layer 26 will be a material having a charge opposite the substrate surface charge. For example, if the substrate surface is positively charged, the first material layer 26 will be negatively charged. Similarly, if the substrate surface is negatively charged, the first material layer 26 will be positively charged.

If there is more than one high refractive index layer in a sensor, the first and second material layers in the high refractive index layers may be the same or different. Within any given high refractive index layer, the combinations of the first and second material layers may be the same or they may be different. For example, one high refractive index layer may be a combination of PDDA+/Poly S-119/PDDA+/Poly R-478 material layers.

Each low refractive index layer 18 is made up of alternating oppositely charged third and forth material layers 30 and 32 and constructed in accordance with the principles of the electrostatic self-assembly method. Examples of third and forth material layers for a low refractive index layer combinations include, but are not limited to, the combination of PDDA+ and PSS−.

The thickness of each layer of oppositely charged material layer can vary depending upon the application of the sensor and the desired properties of the sensor. Each layer of oppositely charged material may range from about 0.1 nm to about 100 nm.

To reduce delamination of the material layers, an interlayer bonding layer 17 is introduced between one or more material layers of the sensor. The interlayer bonding layer promotes adhesion between alternating material layers. In a preferred embodiment, the interlayer bonding layer is such that it increases the hydrogen bonding between individual material layers within the layer-by-layer film assembly. When PDDA+ is being used as one of the materials to prepare the sensor, a preferred interlayer bonding material to achieve such increased interlayer bonding is the PDDA+/polyacrylamide copolymer.

The PDDA/polyacrylamide copolymer may be included between any material layers that includes PDDA+. The PDDA/polyacrylamide copolymer is preferably added as it own layer in the sensor during electrostatic self-assembly. The layer is preferrably at least a monolayer thick. The PDDA/polyacrylamide copolymer will increase hydrogen bonding interaction between the adjacent negatively charged layers. While the PDDA+/polyacrylaminde copolymer is a preferred material, other which are compatible with the material layers and promote adhesion between the material layers may be used to achieve the desired adhesion between oppositely charged layers thus reducing mechanical degradation and delamination.

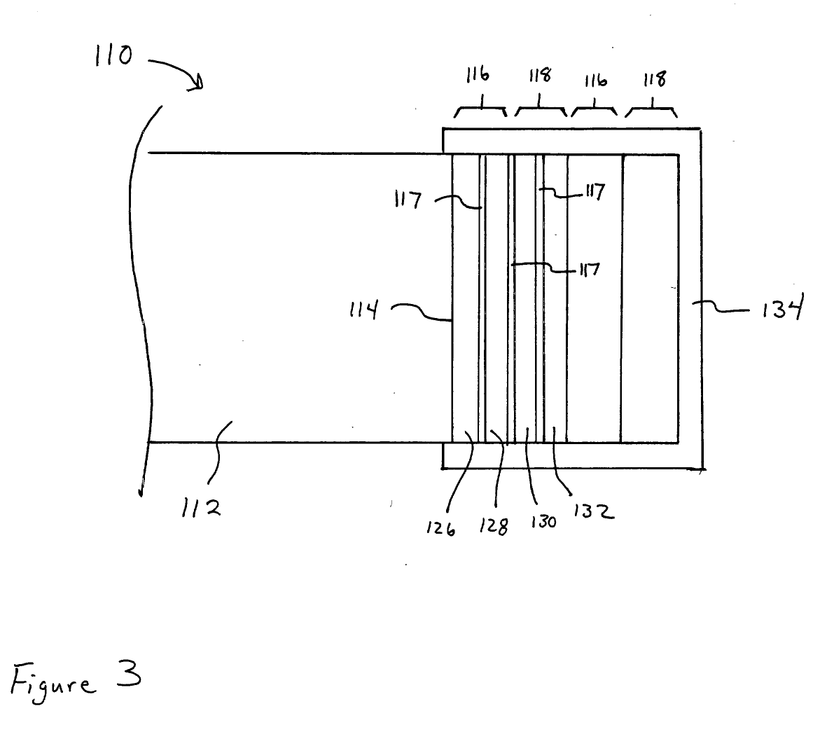

Turning now to FIG. 3, there is shown another embodiment of the present invention. The sensor 110 is similar the previously described sensor 10. For example, the sensor 110 includes alternating high refractive index layers 116 and low refractive index layers 118. The high refractive index layers 116 may have alternating oppositely charged first and second material layers 126 and 128. Likewise the low refractive index layers 118 may have alternating oppositely charged third and forth material layers 130 and 132. Each of the material layers and combinations are the same as that described for sensor 10 in FIG. 2. Further, an interlayer bonding layer 117 may be added to the between the first, second, third, or forth materials in the same manner as described above.

Sensor 110 is directed to including an overlayer 134 over the top and the sides of the layers 116 and 118 of the sensor to enhance the mechanical robustness of the sensor. The overlayer 134 is used to effectively hold the layers of the thin film securely on the substrate surface 114. The overlayer 134 may be a resinous material and is preferably a material in which the thickness and molecular transport properties may be controlled. In one embodiment, the overlayer may be made of the PDDA+/polyacrylamide copolymer. The size and thickness of the overlayer will depend on the desired responsiveness of the sensor and the species being monitored. In one embodiment, the interlayer may have a thickness ranging from about 1 nm to about 100 nm.

The PDDA+/polyacrylamide copolymer material, or other similar bond enhancement material, may be applied as a single layer or as part of multiple layers. Multiple layers may be achieved using the layer-by-layer processing method in which each of the alternating layers has an opposite electrical charge. Single layers may be achieved using this method, or by simple dip coating. The overlayer 134 is preferably applied by dip coating the sensor to a depth that substantially covers the alternating layers 116 and 118. By varying the processing conditions during dip coating, it is possible to vary the thickness of the total deposited coating, as well as its physical structure. Changing the physical structure allows control over porosity and molecular transport properties, and, for the sensor, control over the response time to changes in humidity.

The incorporation of the interlayer bonding layers, and the incorporation of the strong top bonding layer, in accordance with the present invention reduces mechanical fragility of previously reported and described devices, but does not significantly increase the risetime of the resulting humidity sensor elements. This is due to the degree of control allowed over the thickness, structure and transport and molecular diffusion properties of these additional layers. In order to achieve desired fast response time, and as small a risetime as possible, processing conditions, including but not limited to pH, temperature and solution concentration, may be optimized. In particular, thickness may be made small and transport properties adequate to allow fast response times.

In addition to measuring humidity, the sensors of the present invention may be used for measuring flow dynamics and flow, specifically due to their fast response time. To measure flow properties, multiple sensors need to be arranged in a region where air flows. By knowing the distance between the sensor locations, and by measuring the humidity versus time at each location, the velocity of the air between the two sensor locations may be determined from the equation v=(separation distance)/(time between detection of humidity change at two sensor locations). This simple calculation is made possible and practical by the fast response time of the improved humidity sensor with mechanically robust properties. The fast response time makes the ability to determine the difference between the two arrival times noted in the denominator of the equation possible with better precision that would be possible with slower response time.

The fast response time also makes it possible to locate the individual sensors closer together, and with good velocity signal precision, than would be possible using sensors with slower response time. Closely-spaced sensors are important, for example, either where good spatial sensitivity concerning flow characteristics are needed, or where the space in which flow analysis must be made is very small. A preferred embodiment of such sensors is as air flow diagnostic sensors for the breathing and respiration of humans, especially children, or other animals.

The same sensors previously described may be used to measure the concentration of other airborne chemicals other than water vapor. Thus the sensors assembled in the in accordance with the present invention may be used to measure other materials that modify the reflection properties of the sensor films. The sensors appear to be sensitive to hydrocarbon compounds, carbon monoxide, carbon dioxide and other targets depending upon the composition of the individual layers of the sensing films.

The sensor may be designed to monitor humidity, flow dynamics, flow velocity, airborne chemicals, water vapor, hydrocarbon compounds, carbon monoxide, carbon dioxide and other compounds or chemicals with low vapor pressure. The individual layer materials for the above described sensors are preferably chosen to change their reflective properties on exposure to materials such as, but not limited to, hydrocarbons, carbon monoxide, carbon dioxide and other similar molecular targets of interest to the analysis of breathing and respiratory analysis.

In operation of the sensor, reflection and source reference signals may be compared in order to reduce measurement errors caused by random intensity fluctuations of the source output power or propagation path.

The following examples are provide to illustrate certain embodiments of the present invention and are not meant to limit the scope of the present invention in any way.

### EXAMPLE 1

The near real-time response of the disclosed sensor elements that incorporate a top protective layer that does not significantly impede molecular transport and thus does not significantly reduce the temporal risetime of the sensor element response to humidity or to other chemistries in the environment surrounding the distal end of the fiber has been demonstrated. For example, to measure the nominal 10-90% temporal risetime of the self-assembled humidity sensors with such a protective top layer, we have used a simple burst release experimental test arrangement. A small water-filled polymer bladder was pressurized using water from a laboratory supply. A diaphragm formed by an exposed side of this water-filled bladder was positioned near the distal end of the fiber sensor and punctured, creating a fast risetime pressure and humidity wave in the surrounding air. A sensor with alternating layers of poly S-119− and PDDA+ separated by a layer of PDDA+/polyacrylamide copolyer was tested. The corresponding risetime of the sensor and support electronics was measured to be 0.92 milliseconds. This is significantly faster than the risetime of conventional commercial humidity sensors that have response times from tens of seconds to hundreds of seconds.

### EXAMPLE 2

The environmental robustness of the sensor end with an overlayer, and the fast risetime have been demonstrated for sensors of the present invention. The robustness enables practical measurements in a variety of applications. The risetime allows for immediate response, and direct use in closed-loop control system applications.

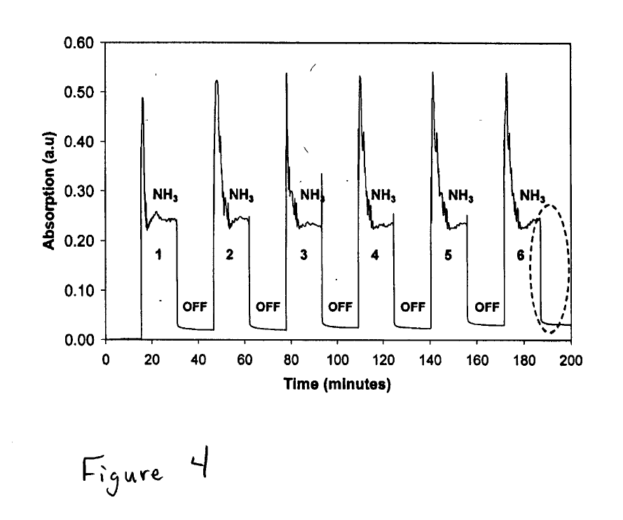

FIG. 4 shows the response of a sensor with alternating layers of ZnO₂ and PDDA that have a PDDA+/polyacrylamide protective overlayer. Again, it is seen that the sensor is responsive to changes in chemical concentration surrounding the fiber end, here ammonia rather than water vapor. In general, many other types of chemistries may be detected using the same approach of a chemically sensitive self-assembled set of molecular layers with the overlayer protective layer claimed here.

Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims and the equivalents thereof.

What is claimed is:

1. A sensor comprising:
alternating layers of high and low refractive indices on an end of a substrate, wherein said layer having a high refractive index comprises multiple oppositely charged layers of at least a first and second material layers, and wherein said layer having a low refractive index comprises multiple oppositely charged layers of at least a third and forth material layers; and
an overlayer substantially surrounding said alternating layers.

2. The sensor of claim 1 wherein said first material layer is selected from the group consisting of poly S-119, poly R-478, ZnO₂, and SnO₂, and said second material layer is PDDA.

3. The sensor of claim 1 wherein said third material layer is PSS and said fourth material layer is PDDA.

4. The sensor of claim 1 wherein said first material layer is poly S119, said second material layer is PDDA, said third material layer is PSS, and said fourth material layer is PDDA.

5. The sensor of claim 1 wherein at least one of said first, second, third, and forth material layers is separated by an interlayer bonding layer comprising a copolymer of PDDA and polyacrylamide.

6. The sensor of claim 1 wherein the number of alternating layers of high and low refractive indices ranges from about 1 to about 50.

7. The sensor of claim 1 wherein the layer having a high refractive index has a refractive index of at least about 1.55.

8. The sensor of claim 1 wherein the layer having a low refractive index has a refractive index lower than about 1.52

9. The sensor of claim 1 wherein each oppositely charged layers range from about 0.1 nm to about 100 nm thick.

10. The sensor of claim 1 wherein said overlayer is a resinous material selected from the group consisting of polymers with controlled thickness and molecular transport properties.

11. The sensor of claim 1 wherein said overlayer has a thickness ranging from about 1 nm to about 100 nm

12. The sensor of claim 1 wherein said substrate is selected from the group consisting of glass, an optical fiber, singlemode fiber, multimode fiber, an optical wave guide, and an optical substrate.

13. An optical sensor comprising:
at least two alternating layers having different refractive indices on an end of a substrate wherein one alternating layer comprises multiple oppositely charged layers of at least a first and second material layer held together by electrostatic charges, and wherein the second alternating layer comprises multiple oppositely charged layers of at least a third and forth material layer held together by electrostatic charges, wherein at least one of said first, second, third, and forth material layers is separated by an interlayer bonding layer.

14. The optical sensor of claim 13 wherein said at least two alternating layers have refractive indices differing by at least about 0.03.

15. The optical sensor of claim 13 wherein said interlayer bonding layer comprises a copolymer of PDDA and polyacrylamide.

16. The optical sensor of claim 13 wherein said substrate is selected from the group consisting of glass, an optical fiber, singlemode fiber, multimode fiber, an optical wave guide, and an optical substrate.

17. The optical sensor of claim 13 wherein said interlayer bonding layer is a material selected from the group consisting of polymers with controlled thickness and molecular transport properties.

18. The optical sensor of claim 13 wherein said first material layer is selected from the group consisting of poly S-119, poly R-478, ZnO₂, and SnO₂, and said second material layer is PDDA.

19. The sensor of claim 13 wherein said third material layer is PSS and said fourth material layer is PDDA.
